(19) United States
(12) Patent Application Publication
(10) Pub. No.: US 2021/0406734 A1
(43) Pub. Date: Dec. 30, 2021

(54) Cognitive Machine Learning System for Mixed Mode Aviation

(71) Applicant: Aquiline Drone Corporation, Hardford, CT (US)

(72) Inventor: Dalton PONT, Aldie, VA (US)

(21) Appl. No.: 17/355,806

(22) Filed: Jun. 23, 2021

Related U.S. Application Data
(60) Provisional application No. 63/043,762, filed on Jun. 24, 2020.

(51) Int. Cl. G06N 5/04; G06F 40/30; G06N 3/04

(52) U.S. Cl. CPC G06N 5/04; G06N 3/04; G06F 40/30

(57) ABSTRACT

Embodiments include systems and methods for generating recommendations using an aviation cognitive digital agent. A trained Deep Neural Language Network (DNLN) configured to map users and actions to a shared semantic space can be received, where the DNLN is trained using mixed domain historic aviation data that includes user features and action features. Input data including features descriptive of an aviation event can be received. Based on the input data, an output vector can be generated using the trained DNLN that maps the input data to the shared semantic space. The output vector can be processed with a plurality of candidate vectors to generate one or more recommendations for the aviation event, wherein the candidate vectors correspond to candidate actions for the aviation event and the candidate vectors have been mapped to the shared semantic space.

### FIELD

The embodiments of the present disclosure generally relate to generating recommendations using an aviation cognitive digital agent.

### BACKGROUND

Rapid Response Mixed Mode (“R2M2”) aviation operations present an evolving set of circumstances that can cause unique and specific challenges. Because of the role R2M2 aviation plays in multiple life critical markets (e.g., medical, military, disaster, aid, emergency, etc.), solutions to these challenges are becoming increasingly important. However, conventional learning approaches have had only a limited impact due to the complexity of the R2M2 scenarios. Accordingly, a machine learning system that is able to efficiently learn from aviation data to provide real-world recommendations for R2M2 scenarios would generate significant benefits.

### SUMMARY

The embodiments of the present disclosure are generally directed to systems and methods for generating recommendations using an aviation cognitive digital agent.

A trained Deep Neural Language Network (DNLN) configured to map users and actions to a shared semantic space can be received, where the DNLN is trained using mixed domain historic aviation data that includes user features and action features. Input data including features descriptive of an aviation event can be received. Based on the input data, an output vector can be generated using the trained DNLN that maps the input data to the shared semantic space. The output vector can be processed with a plurality of candidate vectors to generate one or more recommendations for the aviation event, wherein the candidate vectors correspond to candidate actions for the aviation event and the candidate vectors have been mapped to the shared semantic space.

Features and advantages of the embodiments are set forth in the description which follows, or will be apparent from the description, or may be learned by practice of the disclosure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for generating recommendations using an aviation cognitive digital agent according to an example embodiment.

FIG. 2 illustrates a block diagram of a computing device operatively coupled to a system according to an example embodiment.

FIG. 3 illustrates customers and services for a cognitive digital agent according to an example embodiment.

FIG. 4 illustrates components for a cognitive digital agent according to an example embodiment.

FIG. 5 illustrates an aviation knowledge base (“AKB”) according to an example embodiment.

FIG. 6 illustrates an avatar for a cognitive digital agent according to an example embodiment.

FIG. 7 illustrates user action mappings according to an example embodiment.

FIG. 8 illustrates a machine learning component for generating aviation recommendations according to an example embodiment.

FIG. 9 illustrates a machine learning component for generating aviation recommendations using multiple views according to an example embodiment.

FIG. 10 illustrates a flow diagram for generating recommendations using an aviation cognitive digital agent according to an example embodiment.

### DETAILED DESCRIPTION

Embodiments generate recommendations using an aviation cognitive digital agent. For example, the Cognitive Digital Agent (“CDA”) can be used to generated recommendations for Rapid Response Mixed Mode (“R2M2”) Aviation Operations. Some embodiments of the CDA are a modular and layered cognitive system supported by a human-like user interface. Natural language processing techniques are implemented to process aviation data for learning/input and, in some embodiments, to support a human-like user interface for the digital agent. In some embodiments, the digital agent and/or recommendation engine can be known as Spartacus.

Embodiments of the recommendation engine can include a machine learning component, such as a neural network, that is trained using historic aviation data. The trained machine learning component can be configured to map features sets into a shared semantic space. For example, a trained neural network can be configured to map user features and action features into the shared semantic space. Input data related to an aviation event can be fed into the trained machine learning component, and based on the output one or more recommendations can be generated. These recommendations can be provided to a user, for example using a digital agent. In some embodiments, feedback about the recommendation is received from the user to further enhance the recommendation system.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

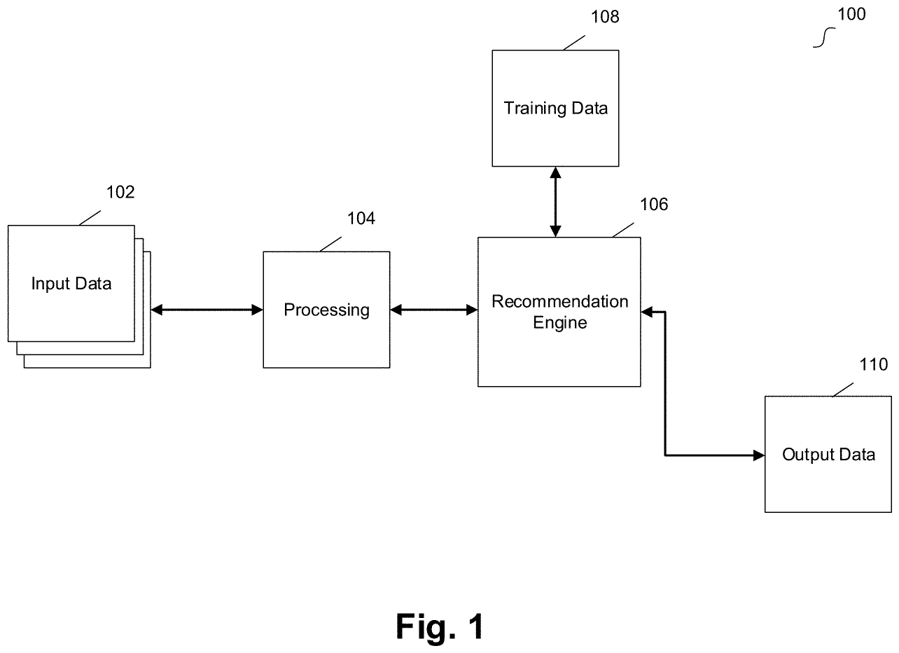

FIG. 1 illustrates a system for generating recommendations using an aviation cognitive digital agent according to an example embodiment. System 100 includes input data 102, processing model 104, recommendation engine 106, training data 108, and output data 110. Input data 102 can include data descriptive of (e.g., that contains features for) an aviation event. In some embodiments, input data 102 can include several elements or rows of data, and the data can be processed by processing module 104. For example, processing module 104 can process input data 102 such that the data can be fed into recommendation engine 106.

In some embodiments, recommendation engine 106 can be a machine learning module (e.g., neural network) that is trained by training data 108. For example, training data 108 can include aviation data, such as historic aviation data that includes user features and action features. In some embodiments, the output from processing module 104, such as the processed input data (e.g., process features of an aviation event), can be fed as input to recommendation engine 106. Recommendation engine 106 can generate output data 110, such as recommendations for the aviation event.

Embodiments use machine learning models, such as neural network, to generate recommendations. Neural Networks can include multiple nodes called neurons that are connected to other neurons via links or synapses. In some embodiments, neurons in a trained neural network can perform a small mathematical operation on given input data, where their corresponding weights (or relevance) are used to produce an operand to be passed further into the network or given as the output. A synapse can connect two neurons with a corresponding weight/relevance. Some implementations of neural networks can map input data into a semantic space. Recommendation engine 106 from FIG. 1 can include a neural network.

The design of recommendation engine 106 can include any suitable machine learning model components (e.g., a neural network, support vector machine, specialized regression model, and the like). For example, a neural network can be implemented along with a given cost function (e.g., for training/gradient calculation). The neural network can include any number of hidden layers (e.g., 0, 1, 2, 3, or many more), and can include feed forward neural networks, recurrent neural networks, convolution neural networks, modular neural networks, and any other suitable type. In some embodiments, the neural network can be configured for deep learning, for example based on the number of hidden layers implemented. In some examples, a Bayesian network can be similarly implemented, or other types of learning models.

For example, a support vector machine can be implemented, in some instances along with one or more kernels (e.g., gaussian kernel, linear kernel, and the like). In some embodiments, recommendation engine 106 can be multiple models stacked, for example with the output of a first model feeding into the input of a second model. Some implementations can include a number of layers of recommendation models.

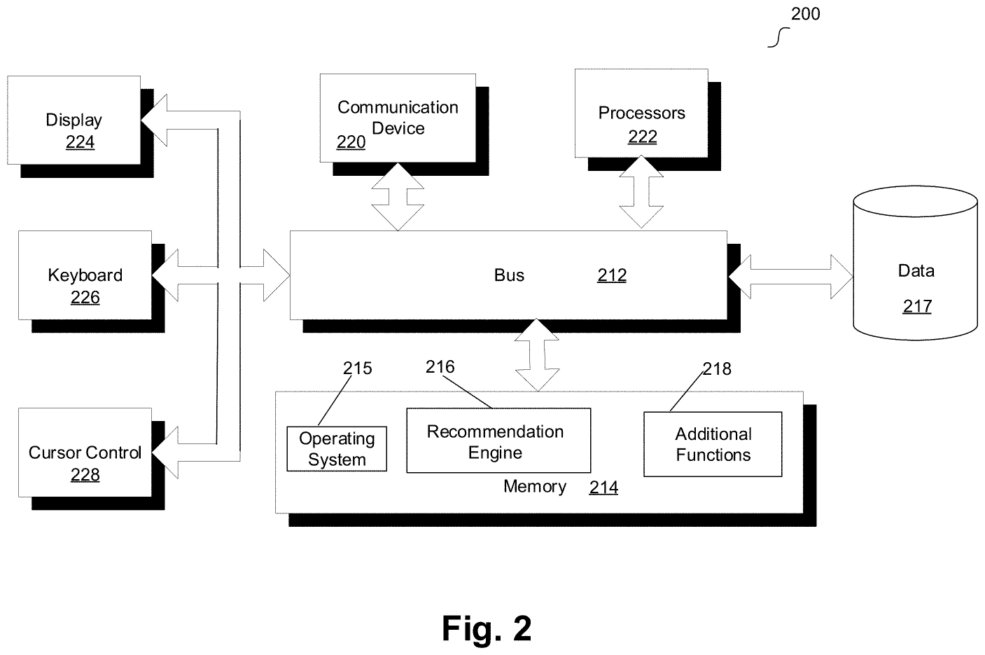

FIG. 2 is a block diagram of a computer server/system 200 in accordance with embodiments. All or portions of system 200 may be used to implement any of the elements shown in FIG. 1. As shown in FIG. 2, system 200 may include a bus device 212 and/or other communication mechanism(s) configured to communicate information between the various components of system 200, such as processor 222 and memory 214. In addition, communication device 220 may enable connectivity between processor 222 and other devices by encoding data to be sent from processor 222 to another device over a network (not shown) and decoding data received from another system over the network for processor 222.

For example, communication device 220 may include a network interface card that is configured to provide wireless network communications. A variety of wireless communication techniques may be used including infrared, radio, Bluetooth®, Wi-Fi, and/or cellular communications. Alternatively, communication device 220 may be configured to provide wired network connection(s), such as an Ethernet connection.

Processor 222 may include one or more general or specific purpose processors to perform computation and control functions of system 200. Processor 222 may include a single integrated circuit, such as a micro-processing device, or may include multiple integrated circuit devices and/or circuit boards working in cooperation to accomplish the functions of processor 222. In addition, processor 222 may execute computer programs, such as operating system 215, recommendation engine 216, and other applications 218, stored within memory 214.

System 200 may include memory 214 for storing information and instructions for execution by processor 222. Memory 214 may contain various components for retrieving, presenting, modifying, and storing data. For example, memory 214 may store software modules that provide functionality when executed by processor 222. The modules may include an operating system 215 that provides operating system functionality for system 200. The modules can include an operating system 215, a recommendation engine 216 that implements the machine learning functionality disclosed herein, as well as other applications modules 218. Operating system 215 provides operating system functionality for system 200. In some instances, recommendation engine 216 may be implemented as an in-memory configuration. In some implementations, when system 200 executes the functionality of recommendation engine 216, it implements a non-conventional specialized computer system that performs the functionality disclosed herein.

Non-transitory memory 214 may include a variety of computer-readable medium that may be accessed by processor 222. For example, memory 214 may include any combination of random access memory (“RAM”), dynamic RAM (“DRAM”), static RAM (“SRAM”), read only memory (“ROM”), flash memory, cache memory, and/or any other type of non-transitory computer-readable medium. Processor 222 is further coupled via bus 212 to a display 224, such as a Liquid Crystal Display (“LCD”). A keyboard 226 and a cursor control device 228, such as a computer mouse, are further coupled to communication device 212 to enable a user to interface with system 200.

In some embodiments, system 200 can be part of a larger system. Therefore, system 200 can include one or more additional functional modules 218 to include the additional functionality. Other applications modules 218 may include various modules of a gaming engine, such as Unity, Unreal, and the like, a game character module, such as Make Human, Maximo, and the like, Natural Language Processing modules or libraries, such as NLTK, Stanford Core, Open NLP, and the like, a CRM, such as Salesforce, Hubspot, and the like, or any other suitable modules.

A database 217 is coupled to bus 212 to provide centralized storage for modules 216 and 218 and to store, for example, data received by recommendation engine 216 or other data sources. Database 217 can store data in an integrated collection of logically-related records or files. Database 217 can be an operational database, an analytical database, a data warehouse, a distributed database, an end-user database, an external database, a navigational database, an in-memory database, a document-oriented database, a real-time database, a relational database, an object-oriented database, a non-relational database, a NoSQL database, Hadoop® distributed file system (“HFDS”), or any other database known in the art.

Although shown as a single system, the functionality of system 200 may be implemented as a distributed system. For example, memory 214 and processor 222 may be distributed across multiple different computers that collectively represent system 200. In one embodiment, system 200 may be part of a device (e.g., smartphone, tablet, computer, etc.). In an embodiment, system 200 may be separate from the device, and may remotely provide the disclosed functionality for the device. Further, one or more components of system 200 may not be included. For example, for functionality as a user or consumer device, system 200 may be a smartphone or other wireless device that includes a processor, memory, and a display, does not include one or more of the other components shown in FIG. 2, and includes additional components not shown in FIG. 2, such as an antenna, transceiver, or any other suitable wireless device component.

Embodiments include a system and method for supporting R2M2 aviation operations using a unique cognitive digital agent built on a Multi-Domain Deep Semantic Recommendation model (“MD-DSR”) that maps both actions and users to a shared semantic space. For example, the mapped shared semantic space data can be processed to recommend actions that have a similarity with similar users (e.g., similarity that meets a threshold with similar uses). Embodiments can leverage this MD-DSR similitude approach to plan and execute complex R2M2 aviation operations in a manner similar to (or identical to) current Federal Aviation Administration (“FAA”) approved/monitored/managed manned aviation operations that include a full range of aircraft & airman certifications, flight planning, flight authorizations, safety procedures, including on-going risk mitigation, Maintenance Repair and Overhaul (“MRO”) activities, and pilot training to optimize safety.

In some embodiments, the recommendations can be accomplished by projecting the actions and users, each represented by a “rich dataset”, to a dense/compact shared latent semantic space (e.g., through non-linear transformation deep-learning layers), where similarity between the two distinct mappings can be optimized. This example technique can allow the model to also learn user ‘behavior’ and ‘traits’ mapping.

In some embodiments, the MD-DSR model can use a ranking based objective that can rank previous mission options. For example, previous missions or historic aviation events can be rated, such as rated as fully successful, partially successful, unsuccessful, or other suitable ratings. In some embodiments, specific aspects of the missions/aviation events can be rated, such as timeliness, budget, compliance, and the like. The missions/aviation event data can be processed to generate training data comprising user-action associations, and the ratings for the missions/aviation events can also be used to refine the techniques for training the recommendation engine using the generated training data.

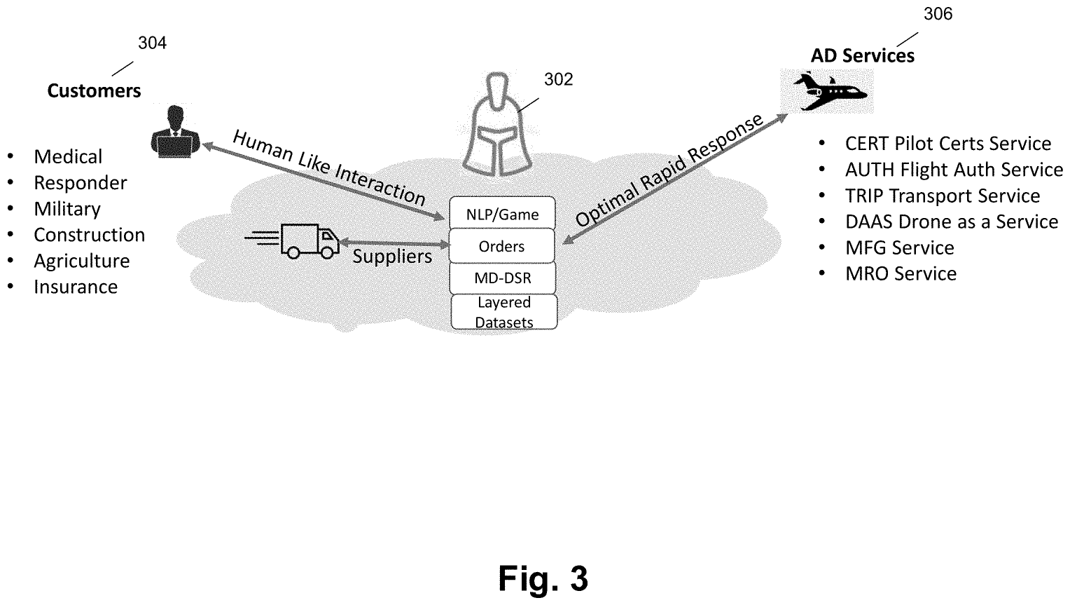

Embodiments can include a multi-functional digital employee that supports multiple-concurrent R2M2 operational tasks. FIG. 3 illustrates customers and services for cognitive digital agent according to an example embodiment. The system of FIG. 3 includes cognitive digital agent 302, customers 304, and services 306. Customers 304 can include medical customers, responders, military customers, construction customers, agriculture customers, insurance customers, and any other suitable customer that can benefit from aviation services, such as rapid response aviation services. Services 306 can include time critical activities supported by embodiments of Spartacus, such as:
Just-in-Time (JIT) Vehicle Manufacturing,
Crew Training/Certification,
Asset Management including Pilot/Crew Assignments,
Flight Planning,
FAA Requests,
Real Time Advisory/Alerts,
Pilot Assists,
Mission Payload Monitoring/Status Communications,
Mission Payload Analytics,
Maintenance Repair and Overhaul (MRO) Activities,
Operations Management including Status, Progress, Coordination, &

Reporting,
Customer Sales/Service,
Drone as a Service,
Manufacturing Service,
Transport Service, and
Any other suitable aviation service.

Rapid response aviation operations, some of which use a mixed fleet of manned and unmanned vehicles, present complex scenarios. Embodiments implement a layered cognitive learning model that uses a hybrid aviation knowledge base of traditional manned and new emerging drone aviation operations. The improved aviation operations achieved by embodiments support running both scheduled and on-demand flights concurrently that safely operate together (e.g., operating similar to conventional manned operations flying in US airspace).

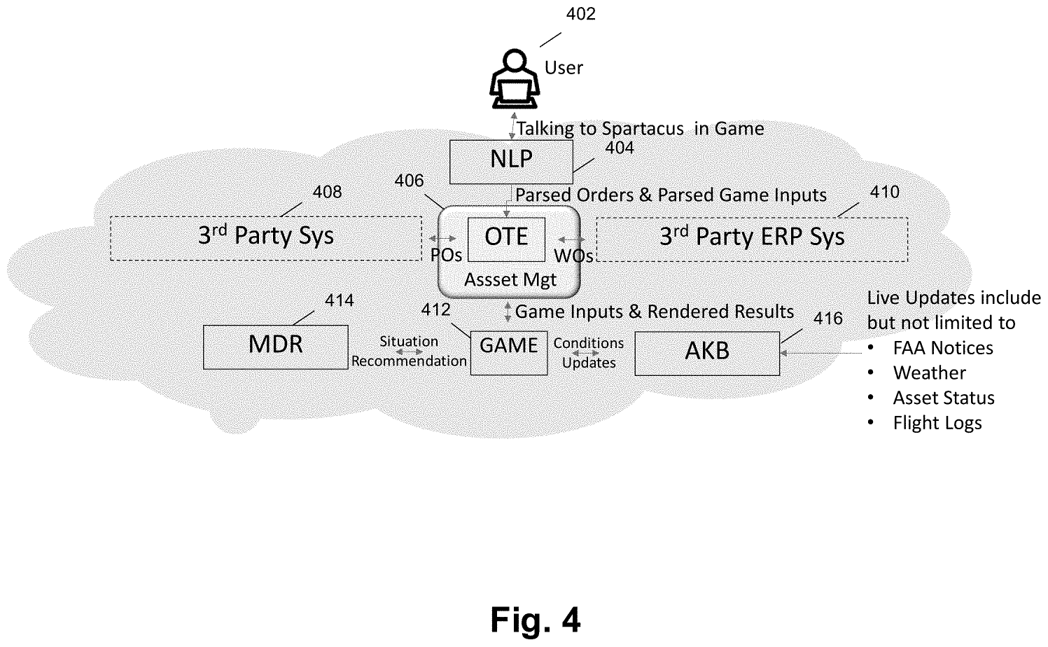

Due to the complexity of the R2M2 aviation operation and its role in serving multiple life critical markets (e.g., medical, military, disaster, aid, emergency, etc.) embodiments include a sophisticated set of components. FIG. 4 illustrates components for a cognitive digital agent according to an example embodiment. The system of FIG. 4 includes users 402, natural language processing engine 404, order/transaction engine 406, third pay systems 408, third party enterprise resource planning system 410, gaming engine 412, multi-domain recommendation engine 414, and aviation knowledge base 416. In some embodiments, these components are hosted in a cloud server architecture with high availability.

Users 402 can include any suitable users that manage, administer, or are otherwise related to flight operations. For example, users 402 can include flight operations staff, technicians, management, and personnel. In some embodiments, users 402 are flight operations personnel that work alongside individuals that operate flights, such as pilots, medical personnel that coordinate transportation, military personnel that coordinate transportation, construction personnel that coordinate transportation, and the like. For example, users 402 can manage the tasks associated with an R2M2 aviation event and provide instructions to other personnel.

Natural langue processing (“NLP”) engine 404 can serve as an interface with users in some embodiments. For example, users can talk with embodiments of Spartacus via the NLP engine 404, which parses words into order streams or gaming streams. In some embodiments, order streams may include but are not limited to product questions, pricing requests, specification inquiries, and purchase confirmations, including checkout interactions. For example, order streams can be aggregated and sent to order/transaction engine 406. In some embodiments, gaming streams may include but are not limited to mission planning inputs, asset allocation statements, MRO suggestions, and all other aviation lifecycle requests or inputs. For example, game inputs can be categorized and formed into user-action pairs as further described below. Game stream can be sent to gaming engine 412 for implementation.

The below table illustrates examples of order streams:

Example Order Streams - To order/transaction engine 406

Where do you fly to out of Boston?
Do you have flights from Richmond on Thu Feb. 21, 2022?
What's the cost of kidney from Atlanta to Richmond?
Confirm purchasing using VISA ending with 7729

The below table illustrates examples of gaming streams:

Example Gaming Streams - To gaming engine 412

What is status of drone N2254L? Where is it?
Where is pilot currently located? Is the crew available?
Where will pilot be Wed Mar. 21, 2020 at 1500?
Flight 2210 drop altitude to 375 and report!

Order/transaction engine 406 can be, but is not limited to, a commercial eCommerce hub/marketplace that handles accounts, product catalogs, pricing sheets, and service descriptions offered by the R2M2 aviation business. For example, order/transaction engine 406 can include a web presence that, in some embodiments, may include a CDA sales agent to assist customers with seeking/learning/purchasing R2M2 services. In some embodiments, order/transaction engine 406 may include a Purchase Order (PO) module to automate acquisition of items, a Work Order (WO) module to automate and coordinate the manufacturing of assets (e.g., which can then flow into an Asset Management module that tracks/status of assets—both aircraft and crew), and other suitable modules.

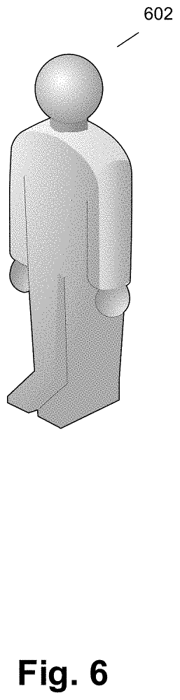

Gaming engine 412 can receive gaming streams and generate recommendations (e.g., using a recommendation engine, as described herein). For example, game scenarios are driven by inputs (e.g., from the live data) and recommendation engine 414 can autonomously generate and present recommendations to designated users at specific situational/interventions with varying and appropriate levels of urgency. In some embodiments, Spartacus can be rendered into an avatar through commercial game character tools and animated through commercial gaming platforms. FIG. 6 illustrates an avatar 602 for a cognitive digital agent according to an example embodiment.

Aviation knowledge base 416 can include a complex combination of public data sources and proprietary data sources (e.g., both live and static data) organized into aviation knowledge base using a schema. For example, aviation knowledge base 416 can include a layered database of R2M2 operations data (e.g., structured, relational, unstructured) covering data such as order management, assignment, flight planning, operations management, mission data processing, data/payload delivery, and close out with post mission surveys. The below illustrates a sample schema for aviation knowledge base 416.

| Table | User | Asset | Order | Missions | Flights |
|---|---|---|---|---|---|
| Purpose | Accnt Mgt | Asst Mgt | Order Mgt | Mission Mgt | Flight Ops |
| Fields | Username | AssetName | Product | Type | Type (U or M) |
| (may | Passwd | Type | Qty | Purpose | Assets (C&A) |
| include | Contact | Status | PurchDate | Objectives | Mission |
| but not | Type | Mi Rate | Delivery Date | Date Range | Start Dt/Time |
| limited to) | | Location | Pickup Loc | Assets (C&A) | Start :oc |
| | | | Delivery Loc | LAANC Auth | End Dt/Time |
| | | | | | End Loc |
| | | | | | Flt Logs |
| | | | | | PyId Logs |
| Updates | Manually | Auto | Manual | Auto, Manual | Auto |
| | | | | Adjust | |
| Examples | Flight | Aircraft | Organ Trans | NE Ohio Gas | MissXYZleg1 |
| | Personnel | Crew | Food Delivery | Field Survey | BDL-BOS |
| | | Grd Eq | Bridge Inspect | Hartford Area | MissXYZleg2 |
| | | Consumables | | Trans Study | BOS-MTN |
| | | | | MCV Kidney | MissXYZleg3 |
| | | | | from BosGen | MTN-RIC |
| | | | | | MissXYZleg4 |
| | | | | | aeRIC-MCV |

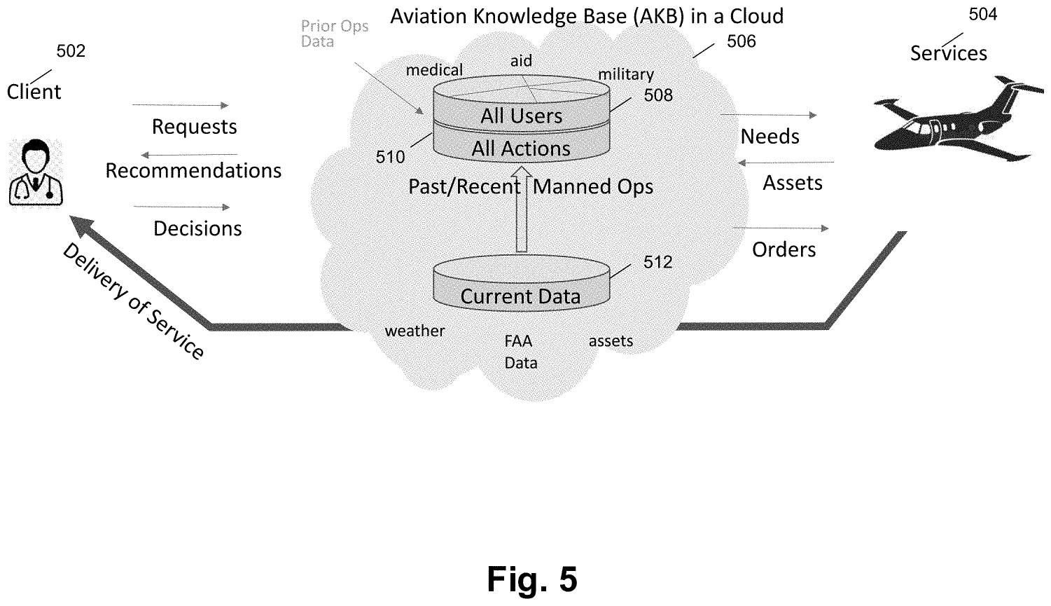

FIG. 5 illustrates an aviation knowledge base (“AKB”) according to an example embodiment. For example, client 502 can submit one or more requests (e.g., request for a flight or aviation event, such as medical or military transportation) which in turn are processed by Spartacus 506 to generate recommendations. These recommendations can then be transmitted to client 502, and client 502 can make one or more decisions (e.g., based on the recommendation).

Spartacus 506 can transmit service needs to services 504 (e.g., computing devices associated with service providers), and services 504 can reply with assets (e.g., assets that can be used to meet the service needs). These assets can be used by embodiments of Spartacus to generate the recommendations for the request(s) received from client 502. Once decisions are received from client 502, Spartacus can provide orders to services 504.

Embodiments of Spartacus 506 leverage the cloud based aviation knowledge base, which includes user data 508, action data 510, and current data 512. For example, user data 508 can include historic user information (e.g., data representing user features), action data 510 can include historic action information (e.g., data representing action features), and current data 512 can include additional features relevant to current or past missions/aviation events (e.g., weather data, Federal Aviation Administration (“FAA”) data, assets, and the like). User data 508, action data 510, and current data 512 (e.g., the aviation knowledge base) support embodiments of the Spartacus recommendation engine, for instance based on associations (e.g., mappings) among the data. The below table represents current data 512 in some embodiments.

| FAA LAANC Data | FAA Ops Data | 3rd Party |
|---|---|---|
| UAS Facility Map | NOTAMs | Weather |
| (UASFM) | | |
| Full-Time Nat Sec UAS | Traffic | Organ/Tissue Trans Hub |
| Flight Restrictions | | |
| (NSUFRs) | | |
| Part-Time NSUFRs | Weather | Grd Service Website |
| Class Airspace | TPRs | Bio Transport |
| Airports | Chart Notices | Vehicle Component Hdbk |
| Stadiums | Aviation Hdbk | MRO Records |
| Wash D.C. FRZ | Aircraft Hdbk | Ops Plans/Specs |
| U.S. Special Use Air | Flight Plans | Cloud Ops Mgt Logs |
| Airspace Schedule | Flight Logs | Payload Logs |
| | ATC Logs | Payload Data Processing |
| | Pilot Logs | |
| | Mishap Reports | |

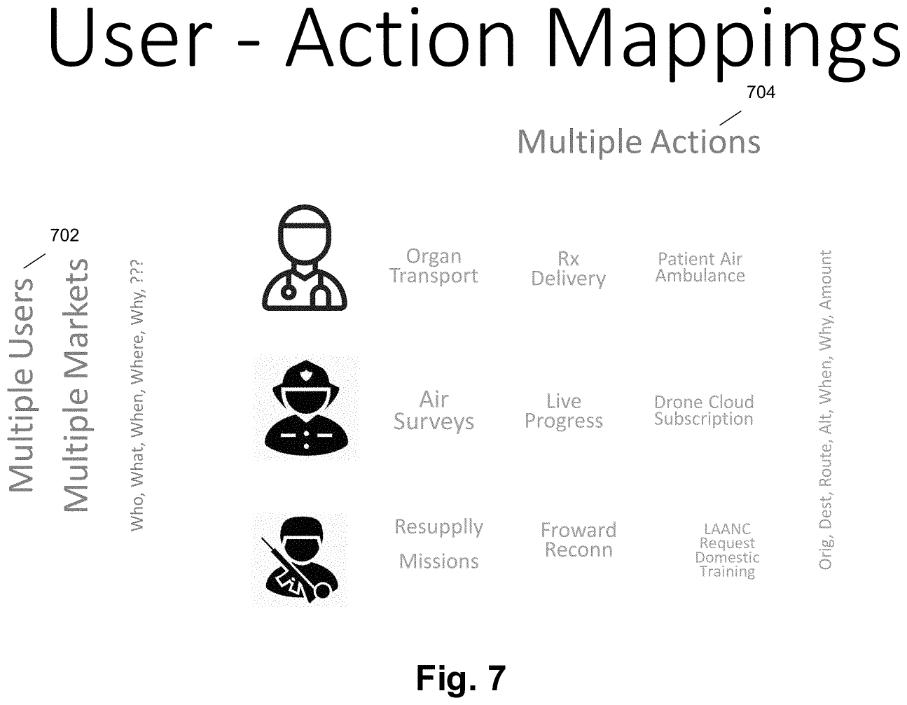

FIG. 7 illustrates user action mappings according to an example embodiment. Embodiments of Spartacus rely on associations between multiple users 702 and multiple actions 704 across multiple domains, such as medical, survey, military, and the like. For example, user-action mappings can be learned (e.g., by the recommendation engine) that associate user features and action features across multiple domains.

Example user features can include identity, chat logs, flight logs, historical mission order and cancelation history including mission type/purpose, origin and destination requests, altitude, routes, cargo type, costs and viability window, temporal window order history, associated mission features (tasks), and the like. In some embodiments, to reduce feature dimensions, data can be normalized, stemmed, and then split into features (e.g., unigram features). Spartacus can use TF-IDF scores (most frequent-to-less frequent) to speed-up parsing and recommendation results.

Example action features can include historic service deliveries which can include but is not limited to delivery/service type, origins and destinations, potential origins and destinations, historic and potential mission types, transportation legs, transportation modes and availability, and historic and current costs for each mode and leg. The code of each action can be encoded as binary features, and then content can be extracted using proprietary NLP parsing (e.g., using letter tri-gram). In some implementations this can result in a 100K feature size per action.

Referring back to FIG. 4, multi-domain recommendation engine 414 can include a Multi-Domain Deep Semantic Recommendation model (“MD-DSR”) that supports learning from data which does not necessarily share a common feature space (e.g., data from different domains). Specifically, instead of a single domain, embodiments of the multi-domain model discover one or more mappings for user features in the latent space such that it is jointly optimized with features of actions from various domains. Embodiments of the multi-domain model improves the recommendation quality across domains at the same time. For example, the non-linear mapping in the MD-DSR model can enable discovery of a compact denser representation of users in the latent space, which can make it more efficient to store the learned user mapping and share the information results across different tasks.

In some embodiments, multi-domain recommendation engine 414 can include a neural network configured to map user features into the user view and the remaining features into different action views. For example, for training purposes, each user view can be matched to one or more action view orders which contain a set of historical users. To achieve this, logged-in users (e.g., proxy users) can be sub-sampled from each user—action view pair and cohort joining based on user IDs can be performed. For example, a single domain deep semantic model can pass its input through two neural networks, one for each of the two different inputs, and can map them into semantic vectors in a shared semantic space.

In some embodiments, for options/document ranking (e.g., options to service a request/order), DSR can compute the relevance score between an order request and available options/document (e.g., as the cosine similarity of their corresponding semantic vectors) and can rank fulfillment options by their similarity scores to previous successful deliveries to the request.

An example of a request/order and user-actions for the request/order follows:

### Example Request/Order:

Fly a liver from Tristar Medical Center to Medical College of Virginia (MCV) at a certain date and time

### Similarity:

(For Liver Transport from prior liver missions*high similarity, some kidney*med similarity, some pancreas*medium similarity, some heart*low similarity, some cells/tissue*low similarity)

### User-Action:

Client—request (submit order): Includes what (e.g., what is being transported), where from (e.g., origin), where to (e.g., destination), when (e.g., date and time).
Flight Ops—obtain pickup address (e.g., derived from client hist data)
Flight Ops—obtain closest asset (e.g., determined from current data)
Flight Ops—pick departure airport (e.g., derived from closest to pick up address and/or historic mission/aviation data)
Flight Ops—confirm favorable weather (e.g., from current data, hist data)
Flight Ops—obtain delivery address (e.g., derived from prior requests)
Flight Ops—pick arrival airport (e.g., derived from closest to destination address and/or historic mission/aviation data)
Flight Ops—Example Recommend Itinerary: date/time, airports, assets, crews, automatically generated flight plan/way points and alternatives, autogenerated LAANC, autogenerated ground service order, autogenerated hotel reservation (if necessary)
Pilot—accept/approve itinerary (mission)
Pilot—schedule mission tabletop
Flight Ops—schedule mission training (if needed)
Flight Ops—confirm/complete any MRO
Crew—confirm flight log
Crew—obtain mission brief update
Flight Ops—issue ground service orders
Crew—obtain mission go authorization
Crew—fly the mission
Pilot—inspect aircraft (per checklist)
Pilot—confirm payload on board
Pilot—Pre-taxi Ready (per checklist and weather, Notice to Airmen (NOTAMS))
Pilot—Seek tower clearance (per checklist, NOTAMS, flight plan) Etc.

In some embodiments, certain tasks or actions can be recommended by embodiments of Spartacus. For example, one or more of the tasks performed by the flight operations personnel (e.g., a user) can be recommended by embodiments of the recommendation engine (e.g., based on previous user-action mappings learned through training and a projection of the user into the shared semantic space). In some embodiments, the pilot performs the takeoff and rotation using recommendations from Spartacus. Embodiments of Spartacus can generate recommendations throughout way point headings, let adjust, navigation guides, to landing and taxi. After landing and taxi, embodiments of Spartacus can continue to generate recommendations for handoff to a ground service and to delivery. For example, these recommendations can be generated for the user (e.g., flight personnel that manages the R2M2 tasks) and the user can provide instruction to the relevant party (e.g., pilot, ground crew, and the like). Embodiments can combine new current data from multiple sources and multiple domains in combination with the ranked user-action pairs to improve the fidelity of recommendations such that new request options/recommendations are optimized.

Returning to the recommendation engine, embodiments train a neural network to project the request and the options for service into a shared semantic space using historic aviation data as training data. For example, the neural network can be trained and can generate recommendation using a series of mathematical functions. If x is denoted as the input request vector, y as the output recommendation vector, li where i=1, . . . , N−1, as the intermediate hidden layers, Wi as the i-th weight matrix, and bi as the i-th bias term, example expressions can be represented as:

I1=W1x

Ii=f(Wi Ii−1+bi),i=2, . . . ,N−1

y=f(WNIN−1+bn)

Next the tan h function can be used as the activation function at the output layer and the hidden layers:

Ii,i=2, . . . ,N−1 where:

1−e−2x

f(x)=1+e−2x

Example semantic relevance scores between order request Q and available service options/document D can then be measured as:

R(Q,D)=co sin(yQ,yD)=yQT yD

∥yQ∥·∥yD∥

In the above, yQ and yD can be the semantic vectors of the order request and the transportation logistics options/document available, respectively. For example, given the order request, the options/documents can be sorted by their semantic relevance scores.

In some embodiments, the recommendation engine/multi-domain deep semantic model can use a word hashing layer to represent a word, such as using a letter-trigram vector. For example, given a word abbreviation (e.g., IAD), after adding word boundary symbols (e.g., #IAD#), the word can be segmented into a sequence of letter-n-grams (e.g., letter-tri-grams: #-I-A, IA-D, A-D-#). The word can then be represented as a count vector of letter-tri-grams. Other suitable word representation, sentence representation, or language representation models or techniques can be similarly implemented.

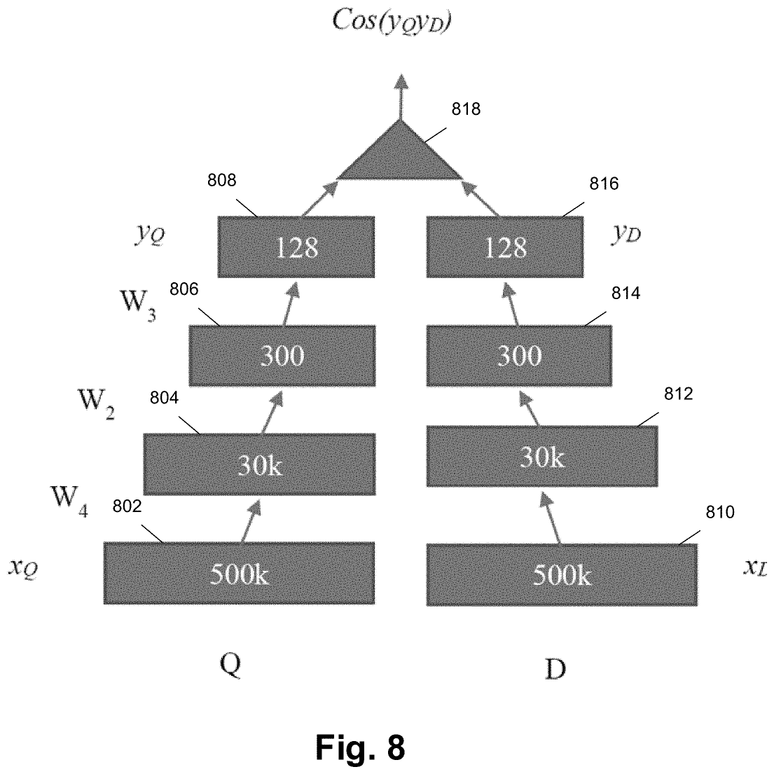

FIG. 8 illustrates a machine learning component for generating aviation recommendations according to an example embodiment. For example, a recommendation engine (e.g., multi-domain recommendation engine 414 of FIG. 4) can implement the machine learning component to generate recommendations from input data (e.g., an order request/aviation event).

In some embodiments, first layers 802 and 810 denote the letter trigram matrix transforming from a term vector to its letter-trigram count vector (which can occur without training/learning in some embodiments). Embodiments implement a letter n-gram or letter trigram approach because the total number of distinct letter-trigrams or letter n-grams is often limited even though the total number of words and abbreviations that represent origins, routes, legs, and destinations may grow to be large. Therefore, embodiments can generalize to new words unseen in the training data. Other suitable representations/transformations may be implemented.

After the first layer, the word-hashed features can then be projected through multiple layers of non-linear projections, in particular through hidden layers 804, 806, and 808 for X_{Q}, the order request, and through hidden layers 812, 814, and 816 for XD, the set of possible relevant options for the order request. While FIG. 8 illustrates sample layer sizes, any suitable hidden layer size can be implemented. The final layer's neural activities can form the features in the semantic space, Y_{Q} and Y_{D}. Note that the input feature dimension e.g., (500K and 500K) in this example are hypothetical and in practice each view can have any suitable features. Example semantic relevance scores between order request Y_{Q} and available service options/document Y_{D} can then be measured at unit 818 (e.g., cosine distance, Euclidean distance, or any other suitable relevance score).

In training, an order request can be considered relevant to the origins, routes, legs, and destinations for that order request, and the parameters (e.g., the weight matrix Wi, of the DSR) can be trained using this signal. The posterior probability of a document/transportation logistics given an order request can be estimated from the semantic relevance score between them through an example function:

R(Q,D)=cosine(Yq,Yd)=(YqTYd)/(∥Yq∥*∥Yd∥)

In the above, D can denote the set of candidate origins, routes, legs, and destinations to be ranked. In some embodiments, some options for D can be explicitly selected (e.g., by a client via a web interface, such as a web form, drop down menu, using a free text web form, and the like) and some options can be unselected, or not explicitly selected. For example, some of the unselected options can be derived/recommended. While D should contain the set of possible relevant options, in practice, for each (order, selected transportation options) pair, denoted by (Q, D+) where Q is an order request and D+ is the selected options, D can be approximated by including D+ and N randomly chosen unselected options, denoted by {Dj−; j=1 . . . N}.

In example training, the model parameters can be estimated to optimize the likelihood of the selected transportation options given the order requests across the training set:

$$∠ ( ⋀ ) = log {Π}_{( Q , D + )} P ( D + \vert Q )$$

In the above, A represents the parameter set of the machine learning component (e.g., neural network).

Embodiments of the Multi-Domain (e.g., one domain to train for each mission, route, leg, and the like) Deep Semantic Models can also map two or more different views of data on to a shared view. For example, a Deep Semantic Model with multiple views (“MV”) can be used to provide multiple domain recommendations by mapping high dimensional sparse features (e.g., raw user features, flight announcements (news), and weather broadcasts) into low-dimensional dense features in a joint semantic space.

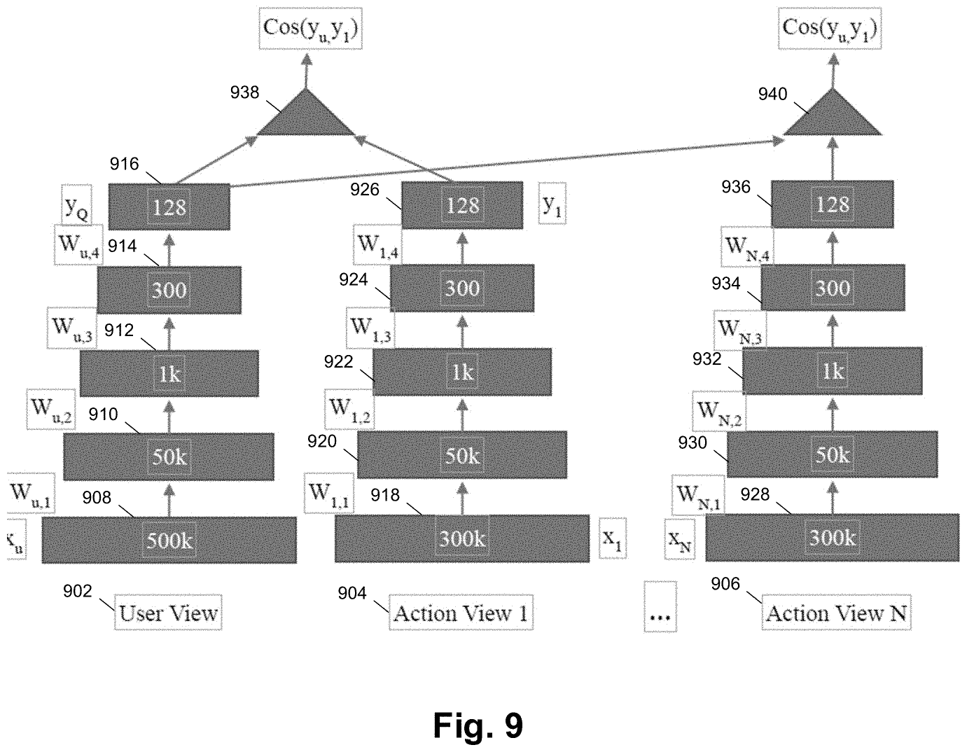

FIG. 9 illustrates a machine learning component for generating aviation recommendations using multiple views according to an example embodiment. For example, a recommendation engine (e.g., multi-domain recommendation engine 414 of FIG. 4) can implement the machine learning component to generate recommendations from input data (e.g., an order request/aviation event).

In FIG. 9, first layers 908, 918, and 928 can accomplish word hashing, similar to the first layers 802 and 810 of FIG. 8. After the first layer, the word-hashed features can then be projected through multiple layers of non-linear projections, in particular through hidden layers 910, 912, 914, and 916 for Xu, the user view, through hidden layers 920, 922, 924, and 926 for X₁, the first action view, and through hidden layers 930, 932, 934, and 936 for X_{N}, the N action view. While FIG. 9 illustrates sample layer sizes, any suitable hidden layer size can be implemented. The final layer's neural activities can form the features in the semantic space, Y_{Q}, Y₁, and Y_{N}. Note that the input feature dimension e.g., (500K and 300K) in this example are hypothetical and in practice each view can have any suitable features. Example semantic relevance scores between user view Y_{Q} and actions Y₁ to Y_{N} can then be measured at units 936 and 938 (e.g., cosine distance, Euclidean distance, or any other suitable relevance score).

Embodiments of the Multi-Domain-Deep Semantic Model (MD-DSR) have more than two views of the aviation knowledge base. In this example setting, v+1 views are available, one pivot view called Xu and other v auxiliary views X1 through Xv and each Xi has its own input domain Xi∈Rdi. In some embodiments, each view also has its own non-linear mapping layer fi (Xi, Wi) which can transform Xi into shared semantic space Yi.

In some embodiments, the training data can contain a set of samples—the jth sample has an instance of the pivot view Xu,j and one active auxiliary view Xa,j where a is the index of the active view in sample j. Other views input Xi: i/=a can be set to 0 vectors in some implementations.

Embodiments can find a non-linear mapping for each view such that the sum of similarities in the semantic space between mapping of the pivot view Yu and mappings of all other views Y1, . . . Yv are optimized/maximized.

$$P = {arg}_{{W}_{p} , {W}_{1} , … {W}_{v}}^{max} W {\sum }_{j = 1}^{\vert N \vert} \frac{{e}^{∝ a cos ( {Y}_{u} {Y}_{a , j} )}}{{Σ}_{{X}^{1} ∈ {R}^{1 a}} {e}^{∝ a cos ( {Y}_{u} , {f}_{a} ( {X}^{1} , {W}_{a} ) )}}$$

In embodiments of the MD-DSR recommendation models, the pivot view Xu can be set to user features and can create an auxiliary view for each different type of actions for recommendation. For example, a single mapping for user's features, namely Wu, that can transform users features into a space that matches different actions selected by the user in different views/domains can be determined. In some embodiments, action types can comprise groupings of similar actions, actions for specific domains (e.g., military, medical transportation, survey, and the like), or any other suitable action types.

This way of sharing parameters can allow cross-domain learning, such as enabling the domains that do not have enough information to learn mappings by leveraging other domains which may possess more data. For example, if users who have similar order history also have similar orders in other domains, those domains can benefit from user mappings learned by these additional domains. In these embodiments, samples from multiple domains can improve grouping similar users more accurately in various domains.

Embodiments of the recommendation engine/MD-DSR can be trained using Stochastic Gradient Decent (“SGD”). For example, each training example can contain cohort pairs of inputs, one for the user view and one for the action data views. Therefore, although one user view exists in the model, some embodiments can have N user feature files, each of which corresponds to an action feature file, where N is the total number of user-action view cohort pairs.

Below is an example high-level flow for training embodiments of the MD-DSR. When taking the derivative with respect to all Wi∈{Wu, W1, . . . Wv} two non-zero derivatives ∂p/∂Wu and ∂p/∂Wa are left, which allows for applying the same update rules for DSR:

| Substituting Q by Xu (U) and D by Xa (A): | |
|---|---|
| 1: Input: N = # of view pairs, M = # of training iterations, | |
| UA = user view architecture, | |
| IA = {IA1 , ...IAN } action view architecture, | |
| UD = {UD1, ...UDN} user input files, | |
| ID = {ID1 ,...IDN} action input files, | |
| WU = user view weight matrix, | |
| WI = {WI 1 , ...WI N } action view weight matrices | |
| 2: Initialization | |
| 3: Initialize WU and WI using UA and IA | |
| 4: for m = 1 to M | |
| 5: | for v = 1 to N |
| 6: | TU ← UDv |
| 7: | TI ← IDv |
| 8: | train WU and WI using TU and TI |

| 9: end for | |
|---|---|
| 10: end for | |
| 11: Output: | WU = final user weight matrix, |

WI = final set of action view weight matrices

In some embodiments, by performing pair-wise training between each user—action view cohort as described in the example training flow, the MD-DSR model can adopt new sets of view pairs which may contain completely independent sets of users and actions at any stage of training. By alternating user—action cohort pairs during a training iteration in some embodiments, the MD-DSR model can converge to an enhanced/optimal embedding of user views that is trained through various action views.

To enhance efficiency at scale, embodiments can use several dimension reduction techniques to control the number of features in the user view. User training examples can also be compacted and summarized, which reduces the number of training data to be linearized to the number of users.

In some embodiments, a top-K of most frequent features can be implemented for training techniques. For example, features that have a probability of 0.005 or greater can be selected to be picked by a user. In some implementations, users may be described well using a relatively small set of frequent features that explains the users' common order behavior. The user's raw features can be preprocessed (e.g., using TF-IDF scores) so that top features can be selected.

In some embodiments, K-means, a common clustering technique that creates a number of clusters such that the sum of distances between each point and the nearest cluster is minimal, can be implemented. For example, similar features can be grouped together into one cluster and a new feature vector Y can be generated (e.g., which has a size equal to a number of clusters K and has a number of appearances of features in cluster i as the value of its ith component).

In some embodiments, this can be accomplished in several ways, and each feature can be represented using a vector fi of length U where U is the of number users in the training data and fi(j) equals the number of times user i has feature j. At times, fi can then be normalized to have length 1. In some embodiments, implementing K-means can cause the relevant distance to be the angle between different feature vectors (e.g., computed using cosine similarity). Then the reduced dimensional vector Yi can be created for each user vector fi. 1≤Cls(a)≤K the cluster assigned to feature a, Yi can be computed using:

$${Y}_{i} ( j ) = {\sum }_{{aiX}_{i} ( a ) > o δ Cls ( a ) = j} {f}_{1} ( a )$$

In some embodiments, to extract a reasonable number of features using K-means, a relatively large number of clusters may be determined, since a small number of clusters can result in large chunk of features in the same cluster. For example, the number of clusters can be set at a minimum of 10k. In some implementations, this means that on average there will be 350+ features per cluster. A cloud-based Map-Reduce implementation can also be used for K-means functionality.

In some embodiments, the training data for each view can contain a set of pairs (Useri, Actionj) such that Useri chose Actionj. At times, a user may choose many actions, which can sometimes cause the training data to grow very large and present inefficient computing tasks. To alleviate this problem, the training data can be compressed in some embodiments so that it includes a single training example per user per each view. For example, the compressed training example can include the user features paired with the features with an average score of all items the user liked in that view. This can reduce the number of training examples per view to the number of users in the training data, which greatly reduce the training data size.

In some embodiments, for each data set system performance can be evaluated based on users who have already had previous interaction (e.g., analogue data-old users, such as in a particular domain or with the Spartacus system) and users who did not have previous interaction, but have some order history that can be encoded into user view (e.g., new users). To evaluate embodiments of MD-DSR, data sets can be split into training and test sets using the following example criteria:

First, each user can be randomly assigned a label of either “train” or “test” in some embodiments. Then, each user with a “test” label can be further labeled as an “old” or “new” user. For those labeled as “old” users, 50% of their actions can be used for training, and the rest for test. For “new” users, their actions can be used for testing (as user—item cohort pairs only are used in the training process in some implementations). Because these users are new to the system, they can be good candidates for evaluation. In some embodiments, for each (useri, itemj) cohort pair in the training data, 9 different semi-random actions can be selected (that include logistics-routes, legs), actionr1, . . . actionr9, where r1 though r9 can be semi-random indices representing missions, and create 9 testing cohort pairs (useri, actionrk), 1≤k≤9 added to the testing data set. Any other suitable approach can be implemented.

This example structure can be used to measure/evaluate how well the system ranks the correct pair (useri, actionj) against the other semi-random action for the same user (useri, actionrk). Embodiments can use two metrics: (1) the Mean Reciprocal Rank (MRR), which computes the inverse of the rank of the correct item among other items, and average the score across the entire testing data, and (2) precision formula, which computes the percentage of times the system ranks the correct item as the top item. Other suitable metrics can be used.

Some embodiments can also implement Collaborative Topic Regression (“CTR”), which is a recommendation model that combines both Bayesian matrix factorization and items/action features to create a recommendation for actions. In the CTR model, two inputs can be provided—a collaborative matrix and action features (represented using bag-of-words or tokens assignments). The model can match users to actions by maximizing the reconstruction error of the collaborative matrix, and by leveraging action features as an extra signal. This helps to model new actions that did not appear before in the training data. For new user recommendations in the scenario, the transpose of the collaborative matrix A can be used as input and supply user features (instead of action features).

For this approach, for two example mission transportation modes data sets, three sets of experiments can be run to train single-view DSR models, each of which corresponds to a dimension reduction method in CTR (e.g., SVD matrix decomposition). Then another three sets of experiments can be run for embodiments of the MD-DSR. The first two can combine mission transportation modes data using Top-k and K-means user features (e.g., MV-Top K and MV-K means). The third set of experiments can train a joint model of two different mission transportation mode features with an added cost feature with Top-k user features (e.g., MV-Top-k).

Embodiments can provide these generated recommendations to a user (e.g., flight personnel), for example using the digital agent. Feedback about the recommendations can be received (e.g., from the user or the user's electronic device). For example, the feedback can include a rating for the recommendation. In another example, the feedback can be a status as to whether the recommendation was accepted, accepted with revision, or rejected for the aviation event. In some embodiments, the feedback can be explicit (e.g., a recommendation is selected for the aviation event) or implicit (e.g., the recommendation is not selected or another recommendation is selected).

In some embodiments, feedback about actions/recommendations can include a rating for a completed aviation event/mission overall. For example, the user action data sets (e.g., used to generate training data) generated through performing a mission/aviation event (e.g., accomplished manually and/or by accepted Spartacus generated recommendations) can be associated with an aviation event/mission, which can include a success profile. The success profile can rank the aviation event/mission on various factors (e.g., timeliness, budget, casualties, number of objectives fully met/partially met, and the like). This feedback can be used to train/update training for the recommendation engine in some embodiments. For example, user action pairs associated with poor ratings can be discarded or demoted for training purposes while user action pairs associated with high ratings can be promoted.

In some embodiments, the recommendation engine is trained using an unsupervised active training process. For example, the input for the unsupervised active training process can be provided by real-time user subject communication monitoring that is implemented through existing workflows (e.g., rather than by a human supervisor in separate/additional workflows).

Embodiments provide a number of advantages over conventional aviation related recommendations. For example, digital assistants such as SIRI, Google Assistant, Bixby, and others use machine learning to perform a subset of basic functions that include organizing and prioritizing information; preparing information artifacts; mediating human communications; scheduling and reasoning in rime; task management; and resource allocation. These digital agents use natural language processing (“NLP”) to communicate with users. Spartacus includes additional functionality that these conventional digital agents lack. As a digital employee, embodiments of Spartacus can include a full human avatar interaction (i.e., not just voice). Embodiments of Spartacus are also built on a complex layered aviation knowledge base which enables Spartacus to achieve functionality that is beyond a conventional computerized assistant.

In addition, these digital assistants require a significant amount of data and training time to learn before they can assist. Embodiments of Spartacus leverage rapid learning through the MD-DSR, which enables Spartacus to understand and use dynamic data (e.g., live data) in almost real time with cognitive ability to know when and how to elevate to human employees.

There are also a number of commercially available artificial intelligence (“AI”) and/or business intelligence (“BI”) based recommendation engines integrated into commercial database products. Most AI and other types of deep-learning recommendation models suffer from significant drawbacks, such as the cold start dilemma. The cold start dilemma involves a lack of user history, dialog history, and/or successful or failed mission history on which to base a future recommendation. To address these issues and successfully plan and execute R2M2 flight operations, embodiments of Spartacus can uniquely extract both successful human-planned and executed missions of historical manned-flight missions along with planned unmanned missions—‘actions’ (e.g., flight operation related actions) and create a user decision matrix factorization that includes decision variables—‘users’—made in order to configure/train embodiments of the MD-DSR model.

There are a number of commercial gaming platforms and natural language processing options that have been combined to create human-like interactions with a computer, but none of these have not been integrated with an Aviation Knowledge Base (“AKB”) (or a similar knowledge base) and they are not configured to receive live data updates that are integrated into a recommendation engine to enable a digital employee to perform rapid response aviation operations, some of which can include a complex fleet of mixed manned and unmanned aircraft.

Some other systems include an on-demand mission planning assistant that assesses multiple sources for flight options based on several potential operators. For example, an artificial intelligence engine can use route optimization algorithms to recommend the fastest and least expensive route options for a given start and finish location, using a traditional computer user interface. However, these systems are limited by conventional interfaces (e.g., they do not include a digital employee that can interact via a human like interface). In addition, these systems merely focus on mission planning/route optimization, however they cannot achieve optimized operations that relate to asset creation (e.g., crew training and manufacturing), mission planning, mission operation, flight management (both remote and manned), contingency/flight alteration, payload/processing/delivery, asset maintenance, asset retirement, and the like. In other words, the AI and/or machine learning that drives the mission planning/route optimization in these systems is not akin to the machine learning that supports the functionality of the embodiments of Spartacus. A number of commercial aviation database products also assist pilots and aviation flight operations, but these similarly lack the machine learning that supports the dynamic functionality of embodiments of Spartacus.

There are numerous autopilots that can be commanded and controlled by a remote centralized locations (operations center) but autopilots merely navigate and perform key flight maneuvers according to a plan. Conventionally, these auto-pilots do not plan themselves, and many merely assist pilots with flight for a single aircraft. Additional capabilities are required to synchronize multiple missions in multiple domains to meet specific mission objectives, which can be accomplished by some embodiments of Spartacus. There are also multiple aviation training systems for pilots and other crew members that draw on a variety of AI and cognitive capabilities. These systems do not actually perform tasks in an operational aviation scenario (i.e., they do not work with live data) and instead serve primary scenario generation to increase the fidelity of the training experience.

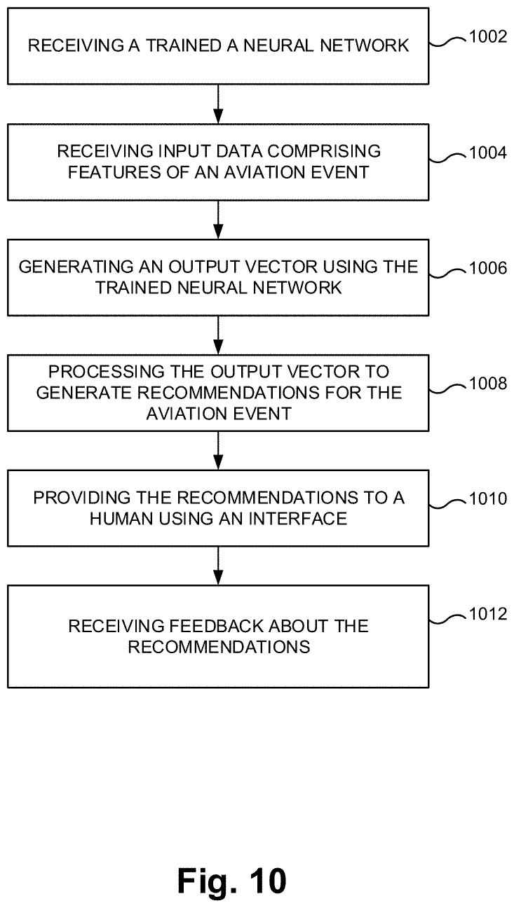

FIG. 10 illustrates a flow diagram for generating recommendations using an aviation cognitive digital agent according to an example embodiment. In some embodiments, the functionality of FIG. 10 is implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In embodiments, the functionality of FIG. 10 can be performed by one or more elements of system 200 of FIG. 2 and/or one or more of the computing elements from FIG. 1.

At 1002, a trained Deep Neural Language Network (DNLN) configured to map users and actions to a shared semantic space can be received. For example, the DNLN can be trained using mixed domain historic aviation data comprising user features and action features. In some embodiments, at least a portion of the user features and action features used to train the DNLN include natural language data. In some embodiments, at least a portion of the features descriptive of the aviation event include natural language data. For example, the user features and action features that include natural language can be converted to an n-gram model for training the DNLN, and the features descriptive of the aviation event that include natural language can be converted to an n-gram model for processing by the DNLN.

In some embodiments, the trained DNLN includes multiple views such that input data is mapped to the shared semantic space using multiple sets of weights that correspond to the multiple views. For example, the multiple views can include at least one user view and a plurality of action views. In some embodiments, mixed domain historic aviation data used to train the DNLN includes a set of communication information derived from a set of conversations and interactions about an aviation event.

At 1004, input data including features descriptive of an aviation event can be received. For example, the input data can include current data, status data, and/or communication data related to the aviation event (e.g., weather data, FAA data, asset data, timing data, arrival timings and status, departure timings and status, positional data, communication data, and the like). In some embodiments, aviation information and operational flight data including live communications during flight can be ingested and aggregated.

At 1006, based on the input data, an output vector can be generated using the trained DNLN that maps the input data to the shared semantic space. For example, the input data can be processed and fed into the trained DNLN to generate the output vector (e.g., vector projected into the shared semantic space).

At 1008, the output vector can be processed with a plurality of candidate vectors to generate one or more recommendations for the aviation event, where the candidate vectors correspond to candidate actions for the aviation event and the candidate vectors have been mapped to the shared semantic space. For example, the candidate vectors can be mapped to the shared semantic space using the trained DNLN. In some embodiments, the generated one or more recommendations can be a plurality of recommendations that correspond to an ordered set of actions for completing the aviation event. In some embodiments, the set of recommendations comprise remedial recommendations or elevation and/or human intervention recommendations.

In some embodiments, processing the output vector with a plurality of candidate vectors includes calculating a distance between the output vector and each of the plurality of candidate vectors. For example, the candidate vectors can be ranked by similarity to the output vector based on the calculated distances, and the generated one or more recommendations can be candidate actions with corresponding candidate vectors that are similar to the output vector according to the ranking. In some embodiments, the calculated distances can be a Euclidean distance or a cosine distance.

In some embodiments, aviation information and operational flight data including live communications during flight can be ingested and aggregated, where the ingested and aggregated aviation information and operational fight data are used to generate real-time action recommendations specific to users. For example, the real-time action recommendations can be generated by feeding the operational flight data into the trained DNLN to generate the output vector and to generate the candidate vectors that correspond to candidate actions for the aviation event.

In some embodiments, the input data including features descriptive of the aviation event can include a set of input data received over a period of time. In some embodiments, a plurality of output vectors can be generated over time using the trained DNLN based on subsets of input data (e.g., an output vector can be generated based on a subset of the input data received at a given time). In some embodiments, a plurality of recommendations can be generated over time for the aviation event by processing a given output vector with a plurality of candidate vectors for the given output vector. For example, the candidate vectors for the given output vector can correspond to candidate actions for the aviation event. In some embodiments, the candidate vectors for the given output vector have been mapped to the shared semantic space based on the set of input data. For example, the candidate vectors for a given output vector can be mapped to the shared semantic space using the trained DNLN based on a subset of input data used to generate the given output vector. In some embodiments, the plurality of recommendations generated over time for the aviation event can be an ordered set of actions for completing the aviation event.

At 1010, the one or more recommendations can be provided to a human using an interface. For example, the interface can be a natural language digital assistant interface that communicates with a user. At 1012, feedback about the recommendations can be received. For example, the interface can be used to provide feedback about the one or more generated recommendations (e.g., from the user). In some embodiments, the feedback can be explicit feedback or implicit feedback.

Embodiments generate recommendations using an aviation cognitive digital agent. For example, the Cognitive Digital Agent (“CDA”) can be used to generated recommendations for Rapid Response Mixed Mode (“R2M2”) Aviation Operations. Some embodiments of the CDA are a modular and layered cognitive system supported by a human-like user interface. Natural language processing techniques are implemented to process aviation data for learning/input and, in some embodiments, to support a human-like user interface for the digital agent. In some embodiments, the digital agent and/or recommendation engine can be known as Spartacus.

Embodiments of the recommendation engine can include a machine learning component, such as a neural network, that is trained using historic aviation data. The trained machine learning component can be configured to map features sets into a shared semantic space. For example, a trained neural network can be configured to map user features and action features into the shared semantic space. Input data related to an aviation event can be fed into the trained machine learning component, and based on the output one or more recommendations can be generated. These recommendations can be provided to a user, for example using a digital agent. In some embodiments, feedback about the recommendation is received from the user to further enhance the recommendation system.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

We claim:

1. A method for generating recommendations using an aviation cognitive digital agent, the method comprising:
receiving a trained Deep Neural Language Network (DNLN) configured to map users and actions to a shared semantic space, wherein the DNLN is trained using mixed domain historic aviation data comprising user features and action features;
receiving input data comprising features descriptive of an aviation event;
generating, based on the input data, an output vector using the trained DNLN that maps the input data to the shared semantic space; and
processing the output vector with a plurality of candidate vectors to generate one or more recommendations for the aviation event, wherein the candidate vectors correspond to candidate actions for the aviation event and the candidate vectors have been mapped to the shared semantic space.

2. The method of claim 1, wherein at least a portion of the user features and action features used to train the DNLN comprise natural language data.

3. The method of claim 2, wherein at least a portion of the features descriptive of the aviation event comprise natural language data.

4. The method of claim 3, wherein the user features and action features that comprise natural language are converted to an n-gram model for training the DNLN, and wherein the features descriptive of the aviation event that comprise natural language are converted to an n-gram model for processing by the DNLN.

5. The method of claim 1, wherein the generated one or more recommendations comprise a plurality of recommendations that correspond to an ordered set of actions for completing the aviation event.

6. The method of claim 5, wherein the candidate vectors have been mapped to the shared semantic space using the trained DNLN.

7. The method of claim 6, wherein the trained DNLN comprises multiple views such that input data is mapped to the shared semantic space using multiple sets of weights that correspond to the multiple views.

8. The method of claim 6, wherein the multiple views comprise at least one user view and a plurality of action views.

9. The method of claim 1, further comprising:
providing, using an interface, the one or more recommendations to a human; and
receiving feedback about the one or more recommendations.

10. The method of claim 9, wherein the interface comprises a natural language digital assistant interface.

11. The method of claim 1, wherein receiving the input data further comprises:
ingesting and aggregating aviation information and operational flight data including live communications during flight, wherein the ingested and aggregated aviation information and operational fight data are used to generate real-time action recommendations specific to users.

12. The method of claim 11, wherein the real-time action recommendations are generated by feeding the operational flight data into the trained DNLN to generate the output vector and to generate the candidate vectors that correspond to candidate actions for the aviation event.

13. The method of claim 12, wherein the set of recommendations comprise remedial recommendations or human intervention recommendations.

14. The method of claim 1, wherein mixed domain historic aviation data used to train the DNLN comprises a set of communication information derived from a set of conversations and interactions about an aviation event.

15. The method of claim 1, wherein processing the output vector with a plurality of candidate vectors further comprises:
calculating a distance between the output vector and each of the plurality of candidate vectors, wherein the candidate vectors are ranked by similarity to the output vector based on the calculated distances, and the generated one or more recommendations comprise candidate actions with corresponding candidate vectors that are similar to the output vector according to the ranking.

16. The method of claim 15, wherein the calculated distances comprise a Euclidean distance or a cosine distance.

17. The method of claim 1, wherein,
the input data comprising features descriptive of the aviation event comprises a set of input data received over a period of time,
a plurality of output vectors are generated over time using the trained DNLN based on subsets of the set of input data, and
a plurality of recommendations are generated over time for the aviation event by processing a given output vector with a plurality of candidate vectors for the given output vector, wherein the candidate vectors for the given output vector correspond to candidate actions for the aviation event, and the candidate vectors for the given output vector have been mapped to the shared semantic space based on the set of input data.

18. The method of claim 17, wherein,
the candidate vectors for a given output vector are mapped to the shared semantic space using the trained DNLN based on a subset of input data used to generate the given output vector, and
the plurality of recommendations generated over time for the aviation event comprise an ordered set of actions for completing the aviation event.

19. A system for generating recommendations using an aviation cognitive digital agent, the system comprising:
a processor; and
a memory storing instructions for execution by the processor, the instructions configuring the processor to:
receive a trained Deep Neural Language Network (DNLN) configured to map users and actions to a shared semantic space, wherein the DNLN is trained using mixed domain historic aviation data comprising user features and action features;
receive input data comprising features descriptive of an aviation event;
generate, based on the input data, an output vector using the trained DNLN that maps the input data to the shared semantic space; and
process the output vector with a plurality of candidate vectors to generate one or more recommendations for the aviation event, wherein the candidate vectors correspond to candidate actions for the aviation event and the candidate vectors have been mapped to the shared semantic space.

20. A non-transitory computer readable medium having instructions stored thereon that, when executed by a processor, cause the processor to generate recommendations using an aviation cognitive digital agent, wherein, when executed, the instructions cause the processor to:
receive a trained Deep Neural Language Network (DNLN) configured to map users and actions to a shared semantic space, wherein the DNLN is trained using mixed domain historic aviation data comprising user features and action features;
receive input data comprising features descriptive of an aviation event;
generate, based on the input data, an output vector using the trained DNLN that maps the input data to the shared semantic space; and
process the output vector with a plurality of candidate vectors to generate one or more recommendations for the aviation event, wherein the candidate vectors correspond to candidate actions for the aviation event and the candidate vectors have been mapped to the shared semantic space.
